(19) United States
(12) Patent Application Publication
(10) Pub. No.: US 2013/0346192 A1
(43) Pub. Date: Dec. 26, 2013

(54) METHOD AND SYSTEM FOR DISPLAYING A THEME BASED ADVERTISEMENT ON A SEARCH BOX

(71) Applicant: Rohit Gyanchand CHATTER, Bangalore (IN)

(72) Inventor: Rohit Gyanchand CHATTER, Bangalore (IN)

(73) Assignee: YAHOO! INC., Sunnyvale, CA (US)

(21) Appl. No.: 13/527,606

(22) Filed: Jun. 20, 2012

(51) Int. Cl. G06Q 30/02; G06F 17/30

(52) U.S. Cl. 705/14.49

(57) ABSTRACT

A method and system for displaying advertisements on a search box. The method includes receiving a search query from a user; determining a match between the search query and an advertisement that is relevant to the search query; retrieving the advertisement; altering one or more data formats associated with the advertisement to generate a theme based advertisement; and displaying, to the user, the theme based advertisement on at least one of the search box and areas encircling the search box. The system includes an electronic device, a communication interface, a memory and a processor to receive a search query, to determine a match between the search query and an advertisement, to retrieve the advertisement, to alter one or more data formats associated with the advertisement and to display the theme based advertisement on at least one of the search box and areas encircling the search box.

### TECHNICAL FIELD

Embodiments of the disclosure relate to the field of advertisements and more specifically, to displaying relevant advertisements, to users, on a webpage.

### BACKGROUND

In recent times, advertisers are using various websites, for example Yahoo! website, for displaying advertisements. In one example, the advertisements are displayed based on a search query of a user and a webpage browsed by the user. The websites charge a price to the advertisers, for displaying the advertisements on the webpage or when the advertisements are clicked by the user. Conventionally, the advertisers participate in an auction model conducted by the websites for deciding a monetary value that is required to be paid, by the advertisers, for displaying the advertisements. One or more advertisers winning a bid in the auction process is enabled to display corresponding advertisements on the webpage. The advertisers remunerate the websites based on a click through rate associated with the advertisements. The click through rate is referred to as number of clicks, performed by various users, on the advertisements.

The advertisements are typically displayed on one or more positions of the webpage based on one or more algorithms. In one example, the advertisements are displayed adjacent to each other at top, at sides or at bottom of the webpage. However, such advertisements are unappealing to the user and hence do not capture attention of the user. As a result, the price invested, by the advertisers, for displaying the advertisements is not used efficiently. Also, displaying such advertisements adjacent to each other clutters the webpage. Further, the websites incur a revenue loss since the click through rate associated with the advertisements is lowered due to lack of the attention of the user on the advertisements displayed.

In the light of the foregoing discussion, there is a need for a method and a system for displaying the advertisements such that users, advertisers and websites are benefitted.

### SUMMARY

The above-mentioned needs are met by a method, a computer program product and a system for displaying advertisements on a search box.

An example of a method of displaying advertisements on a search box includes receiving a search query, from a user, in a search box present on a webpage of a website. The method also includes determining a match between the search query and an advertisement that is relevant to the search query. The match is determined by comparing the search query with a plurality of advertisements present in an advertisement database. Further, the method includes retrieving the advertisement that is relevant to the search query based on a relevance algorithm. The advertisement is being provided by an advertiser winning a bid to display the advertisement. Furthermore, the method includes altering one or more data formats associated with the advertisement to generate a theme based advertisement that corresponds to the search query. The one or more data formats are being altered based on a plurality of search box settings to enable embedding of the theme based advertisement on the search box. Moreover, the method includes displaying, to the user, the theme based advertisement on at least one of the search box and areas encircling the search box.

An example of a computer program product stored on a non-transitory computer-readable medium that when executed by a processor, performs a method of displaying advertisements on a search box includes receiving a search query, from a user, in a search box present on a webpage of a website. The computer program product also includes determining a match between the search query and an advertisement that is relevant to the search query. The match is determined by comparing the search query with a plurality of advertisements present in an advertisement database. Further, the computer program product includes retrieving the advertisement that is relevant to the search query based on a relevance algorithm. The advertisement is being provided by an advertiser winning a bid to display the advertisement. Furthermore, the computer program product includes altering one or more data formats associated with the advertisement to generate a theme based advertisement that corresponds to the search query. The one or more data formats are being altered based on a plurality of search box settings to enable embedding of the theme based advertisement on the search box. Moreover, the computer program product includes displaying, to the user, the theme based advertisement on at least one of the search box and areas encircling the search box.

An example of a system for displaying advertisements on a search box includes an electronic device. The system also includes a communication interface in electronic communication with the electronic device. The system further includes a memory that stores instructions. Further, the system includes a processor responsive to the instructions to receive a search query, from a user, in a search box present on a webpage of a website. The processor is also responsive to the instructions to determine a match between the search query and an advertisement that is relevant to the search query. The match is determined by comparing the search query with a plurality of advertisements present in an advertisement database. The processor is further responsive to the instructions to retrieve the advertisement that is relevant to the search query based on a relevance algorithm. The advertisement is being provided by an advertiser winning a bid to display the advertisement. Further, the processor is responsive to the instructions to alter one or more data formats associated with the advertisement to generate a theme based advertisement that corresponds to the search query. The one or more data formats are being altered based on a plurality of search box settings to enable embedding of the theme based advertisement on the search box. Furthermore the processor is responsive to the instructions to display, to the user, the theme based advertisement on at least one of the search box and areas encircling the search box.

### BRIEF DESCRIPTION OF THE FIGURES

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of an environment, in accordance with which various embodiments can be implemented;

FIG. 2 is a block diagram of a server, in accordance with one embodiment;

FIG. 3 is a flow diagram illustrating a method of displaying advertisements on a search box, in accordance with one embodiment; and

FIGS. 4A-4B is an exemplary illustration of displaying advertisements on a search box, in accordance with one embodiment.

### DETAILED DESCRIPTION OF THE EMBODIMENTS

The above-mentioned needs are met by a method, computer program product and system for displaying advertisements on a search box. The following detailed description is intended to provide example implementations to one of ordinary skill in the art, and is not intended to limit the invention to the explicit disclosure, as one or ordinary skill in the art will understand that variations can be substituted that are within the scope of the invention as described.

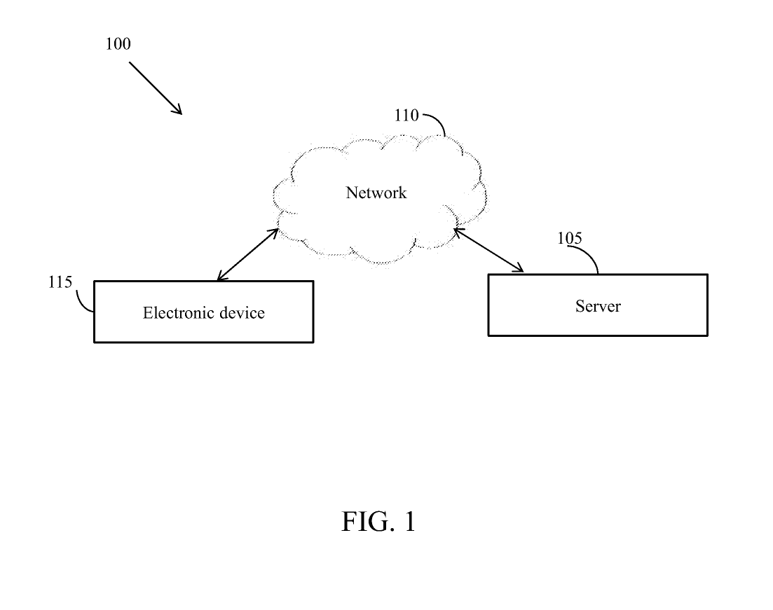

FIG. 1 is a block diagram of an environment 100, in accordance with which various embodiments can be implemented.

The environment 100 includes a server 105 and an electronic device 115. The electronic device 115 can communicate with the server 105 through a network 110. Examples of the electronic device 115 include, but are not limited to, a computer, a mobile phone, a laptop, a palmtop, a hand held device and a personal digital assistant (PDA).

The server 105 is in electronic communication with the electronic device 115 through the network 110. The server 105 can be located remotely with respect to the electronic device 115. Examples of the network 110 include, but are not limited to, a Local Area Network (LAN), a Wireless Local Area Network (WLAN), a Wide Area Network (WAN), internet, and a Small Area Network (SAN).

In some embodiments, an electronic device 115 can perform functions of the server 105.

A user of the electronic device 115 accesses a webpage, for example Yahoo!®, via the electronic device 115 and enters a search query in a search box of a search engine, for example Yahoo!® Web. The search query can be provided in various formats. Examples of the formats include, but are not limited to, text, image and voice.

In one example, the user can type the search query in the search box. In another example, the user can click on an entity displayed on the webpage. The entity clicked on the webpage is considered as the search query. The search query for a particular subject is communicated to the server 105 through the network 110 by the electronic device 115 in response to the user inputting the search query.

The server 105 is configured to determine a match between the search query and an advertisement from a plurality of advertisements present in an advertisement database. The advertisement can also be retrieved based on one or more keywords included in the webpage such that the advertisement is relevant to the search query.

The advertisement is provided by an advertiser winning a bid for displaying the advertisement on the webpage. A relevance algorithm is used to retrieve the advertisement provided by the advertiser. An auction model is generated, by the search engine or the website, that enables a plurality of advertisers to propose one or more bids for displaying the advertisements corresponding to the advertisers.

Further, the server 105 is configured to retrieve the advertisement that is relevant to the search query.

The server 105 then alters one or more data formats associated with the advertisement to retrieve a theme based advertisement that corresponds to the search query. The theme based advertisement is further enabled to be displayed on the search box of the search engine, on areas encircling the search box or both.

The user can further click on the theme based advertisement in order to understand the products or the services advertised in the theme based advertisement. By displaying the theme based advertisement on the search box, probability of the user to view the theme based advertisement is increased. Hence, the advertiser is ensured reachability of the theme based advertisement to the user. Further, the website obtains revenue upon delivering the theme based advertisement to the user.

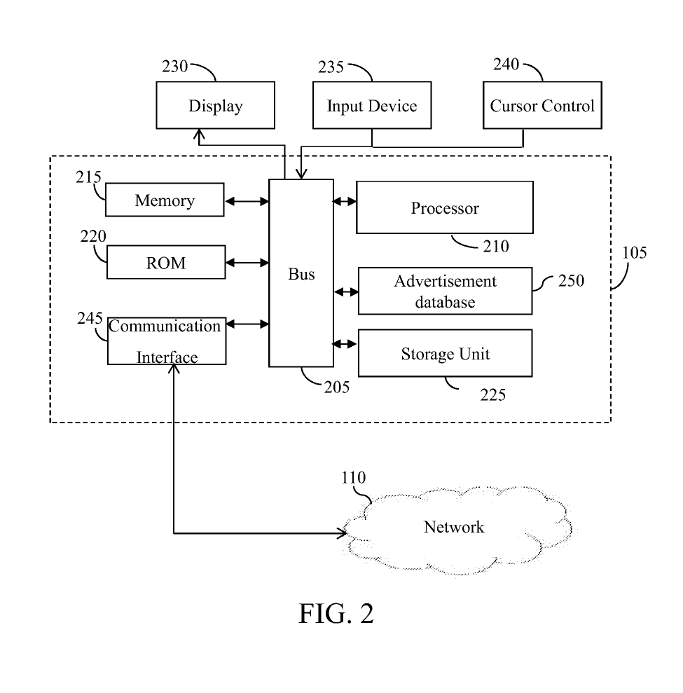

A server 105 including a plurality of elements, for displaying the theme based advertisement on the search box, is explained in detail in conjunction with FIG. 2.

FIG. 2 is a block diagram of a server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example various search queries of a plurality of users and a plurality of advertisements.

The server 105 can be coupled via the bus 205 to a display 230, for example a cathode ray tube (CRT), for displaying the advertisements to the users. The input device 235, including alphanumeric and other keys, is coupled to the bus 205 for communicating information and command selections to the processor 210. Another type of user input device is the cursor control 240, for example a mouse, a trackball, or cursor direction keys for communicating direction information and command selections to the processor 210 and for controlling cursor movement on the display 230.

Various embodiments are related to the use of the server 105 for implementing the techniques described herein. In some embodiments, the techniques are performed by the server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, for example the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that include the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. In any such implementation, the communication interface 245 sends and receives electrical, electromagnetic or optical signals that carry digital data streams representing various types of information.

The processor 210 in the server 105 is configured to receive a search query from a user. The search query is provided to a search box present on a webpage of a website. The processor 210 in the server 105 is also configured to generate a match between the search query and an advertisement. In some embodiments, the processor 210 determines the match by comparing the search query with the advertisements present in an advertisement database 250 that is coupled to the processor 210.

Further, the processor 210 in the server 105 is operable to retrieve the advertisement that is relevant to the search query. The advertisement is provided by an advertiser winning a bid to display the advertisement. The processor 210 is further configured to generate an auction model than enables a plurality of advertisers to propose one or more bids for displaying the advertisements corresponding to the advertisers.

The processor 210 is also configured to alter one or more data formats associated with the advertisement to generate a theme based advertisement that corresponds to the search query. The processor 210 is operable to alter the data formats based on a plurality of search box settings. Altering the data formats associated with the advertisement enables embedding of the advertisement on the search box.

Further, the processor 210 is operable to display the theme based advertisement on the search box. The processor 210 is also operable to display the theme based advertisement on areas encircling the search box. The user can click on the theme based advertisement to view products or services advertised in the theme based advertisement.

By displaying the theme based advertisement on the search box, the areas encircling the search box or both, probability of the user to view the theme based advertisement increases. Also, the advertiser is ensured reachability of the theme based advertisement to the user. Further, the website obtains revenue from the advertiser upon delivering the theme based advertisement to the user.

In some embodiments, the processor 210 is also operable to display search results associated with the search query and a plurality of text advertisements on a webpage.

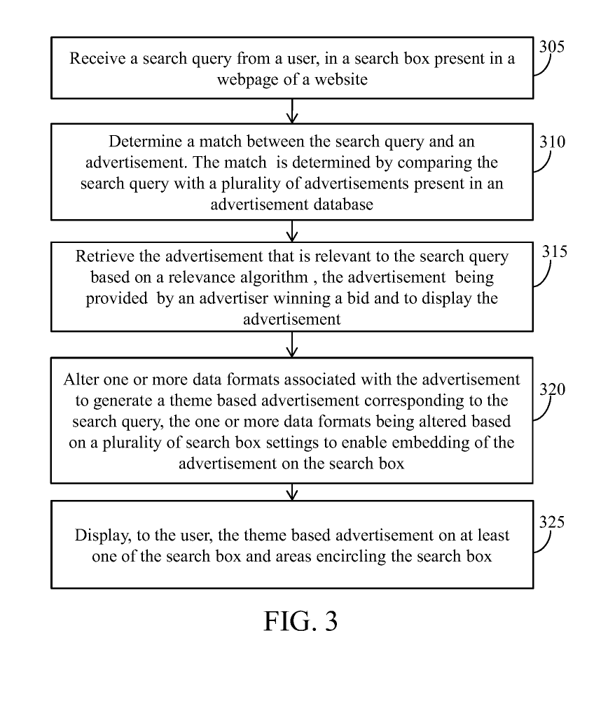

A method of displaying the theme based advertisement, to the user, is explained in detail in conjunction with FIG. 3.

FIG. 3 is a flow diagram illustrating a method of displaying advertisements on a search box, in accordance with one embodiment.

At step 305, a search query is received, from a user, in a search box present on a webpage of a website. The webpage includes one or more entities. Examples of the entities include, but are not limited to, a product, a service, a celebrity, a sport, a city, and tourist spots.

In one example, the user can type the search query in the search box. The search query can also be provided, to the search box, as an image or as voice. The entity can also be displayed on the webpage. The user can click on the entity and the entity clicked, by the user, is considered as the search query.

At step 310, a match between the search query and an advertisement that is relevant to the search query is determined. The match is determined by comparing the search query with a plurality of advertisements present in an advertisement database.

The match between the search query and the advertisements is determined based on one or more attributes. Examples of the attributes include, but are not limited to, a user intent, an amount proposed in a bid, an advertisement quality and user targeting.

In some embodiments, a matching algorithm is used for determining the match between the search query and the advertisement. Examples of the matching algorithms include, but are not limited to, a broad match type algorithm and a phase match type algorithm.

At step 315, the advertisement that is relevant to the search query is retrieved from the advertisement database based on a relevance algorithm. The advertisement is provided by an advertiser winning the bid. The website generates an auction model to enable bidding. The auction model can either be generated prior to displaying the advertisement or in real time. A plurality of advertisers can participate in the auction model for proposing one or more bids for displaying corresponding advertisements. Further, the advertiser winning the bid can display the advertisement.

In one example, if the user types “shoes” as the query, then various advertisements advertising shoes are considered. Further, if one advertiser, for example, Reebok advertiser wins the bid, then Reebok advertisement provided by the Reebok advertiser is retrieved.

Further, the advertiser is required to pay a price proposed in the bid for displaying the advertisement.

In some embodiments, search results associated with the search query and a plurality of text advertisements are also retrieved. The search results associated with the search query is retrieved from one or more web servers. Further, the text advertisements are retrieved from one or more advertisement servers.

At step 320, one or more data formats associated with the advertisement, retrieved at step 315, are altered to generate a theme based advertisement that corresponds to the search query. The data formats, associated with the advertisement, are altered based on a plurality of search box settings that enables embedding of the theme based advertisement on the search box. The search box settings can be provided by, in one example, a website designer.

In one example, an advertisement designer can alter the data formats associated with the advertisement to generate the theme based advertisement.

At step 325, the theme based advertisement is displayed on the search box. The theme based advertisement can also be displayed on areas encircling the search box. The user can click on the theme based advertisement for viewing products and services advertised in the theme based advertisement.

By displaying the theme based advertisement, on the search box, on the areas encircling the search box or both, possibility of the user to view the theme based advertisements is increased since focus of the user is on the search box. Also, the advertiser is ensured reachability of the theme based advertisement to the user. Further, the website obtains revenue from the advertiser upon delivering the theme based advertisement to the user. The revenue is obtained based on number of users clicking on the theme based advertisement displayed on the search box.

Similarly, various theme based advertisements relevant to various queries of the user are displayed on the search box, on the areas encircling the search box or both.

Further, the search results associated with the search query and the text advertisements are also displayed in addition to the theme based advertisement.

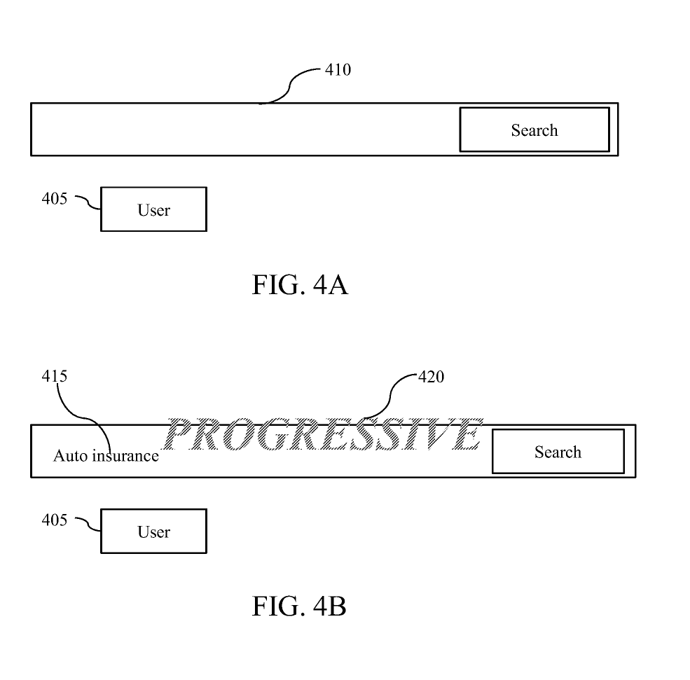

FIGS. 4A-4B is an exemplary illustration of a method of displaying advertisements on a search box, in accordance with one embodiment.

FIG. 4A includes a search box 410 of a search engine, for example Yahoo!® Web Search. The user provides a search query 415 of auto insurance. The user 405 can provide the search query 415 to the search box 410 by typing the search query 415.

Content, for example text, included in the search query 415, is compared with a plurality of advertisements present in an advertisement database. Further, a match between the search query 415 and an advertisement relevant to the search query 415 is determined. The advertisement is provided by an advertiser advertising products or services relevant to the search query 415.

The match between the search query 415 and the advertisement is determined based on an intent, of the user 405, that includes a search for auto insurance as shown in FIG. 4B. The match can also be determined based on a bid proposed by the advertiser of the advertisement. Similarly, various other attributes, for example, user targeting can also be used for determining the match between the search query and the advertisement.

Further, the advertisement is retrieved from the advertisement database. The advertisement is retrieved upon winning the bid by the advertiser of the advertisement. An auction model is generated that enables various advertisers to propose one or more bids. Further, one advertisement of one advertiser winning the bid is retrieved.

Further, search results associated with the search query and a plurality of text advertisements are also retrieved in addition to the advertisement.

Upon retrieving the advertisement, one or more data formats associated with the advertisement is altered. The data formats are altered to generate a theme based advertisement 420, for example progressive, as shown in FIG. 4B. The theme based advertisement 420 advertises an insurance organization providing insurance for various vehicles. Hence, a purpose of the user 405 that includes requirement of auto insurance can be met by the insurance organization advertised in the theme based advertisement 420.

The theme based advertisement 420 is further displayed on the search box 410 as shown in FIG. 4B.

The theme based advertisement 420 can also be displayed on areas encircling the search box 410. The user 405 can click on the theme based advertisement 420 for viewing information on the insurance organization and various process steps for obtaining the auto insurance. Hence, the insurance organization advertised is ensured reachability of services offered to the user 405. Also a website, including the search box 415, obtains revenue upon delivering the theme based advertisement 420 to the user 405.

Furthermore, the search results associated with the search query and a plurality of text advertisements are also displayed on a webpage of the website.

The method specified in the present disclosure enables display of a theme based advertisement that is relevant to a search query of a user. The theme based advertisement is displayed, on a search box, on areas encircling the search box or both, such that probability of the user to view the theme based advertisement increases and further the theme based advertisement enables to solve a purpose of the user. Also, the theme based advertisement is displayed creatively on the search box and hence takes hold of user attention. Therefore, advertisers can reach maximum users by displaying the theme based advertisement. Thus, amount invested on advertisements are utilized efficiently. Also, by displaying the theme based advertisement on the search box, the probability of the user to click on the theme based advertisement increases, thereby generating revenue to the websites or search engines hosting the search box.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of displaying advertisements on a search box, the method comprising:
receiving a search query, from a user, in a search box present on a webpage of a website;
determining a match between the search query and an advertisement that is relevant to the search query, wherein the match is determined by comparing the search query with a plurality of advertisements present in an advertisement database;
retrieving the advertisement that is relevant to the search query based on a relevance algorithm, the advertisement being provided by an advertiser winning a bid to display the advertisement;
altering one or more data formats associated with the advertisement to generate a theme based advertisement that corresponds to the search query, the one or more data formats being altered based on a plurality of search box settings to enable embedding of the theme based advertisement on the search box; and
displaying, to the user, the theme based advertisement on at least one of the search box and areas encircling the search box.

2. The method as claimed in claim 1 and further comprising:
retrieving at least one of a plurality of search results associated with the search query and a plurality of text advertisements.

3. The method as claimed in claim 1 and further comprising:
displaying at least one of a plurality of search results associated with the search query and a plurality of text advertisements.

4. The method as claimed in claim 1, wherein the match between the search query and the advertisement is determined based on one or more attributes.

5. The method as claimed in claim 1, wherein the match between the search query and the advertisement is determined using a matching algorithm.

6. The method as claimed in claim 1 and further comprising:
generating an auction model by the website, wherein the auction model is used to propose one or more bids by a plurality of advertisers to display a corresponding plurality of advertisements.

7. The method as claimed in claim 1, wherein the advertiser is required to pay a price in response to displaying the theme based advertisement on the search box.

8. The method as claimed in claim 1, wherein the theme based advertisement is clickable by the user.

9. A computer program product stored on a non-transitory computer-readable medium that when executed by a processor, performs a method of displaying advertisements on a search box, the method comprising:
receiving a search query, from a user, in a search box present on a webpage of a website;
determining a match between the search query and an advertisement that is relevant to the search query, wherein the match is determined by comparing the search query with a plurality of advertisements present in an advertisement database;
retrieving the advertisement that is relevant to the search query based on a relevance algorithm, the advertisement being provided by an advertiser winning a bid to display the advertisement;
altering one or more data formats associated with the advertisement to generate a theme based advertisement that corresponds to the search query, the one or more data formats being altered based on a plurality of search box settings to enable embedding of the theme based advertisement on the search box; and
displaying, to the user, the theme based advertisement on at least one of the search box and areas encircling the search box.

10. The computer program product as claimed in claim 9 and further comprising:
retrieving at least one of a plurality of search results associated with the search query and a plurality of text advertisements.

11. The computer program product as claimed in claim 9 and further comprising:
displaying at least one of a plurality of search results associated with the search query and a plurality of text advertisements.

12. The computer program product as claimed in claim 9, wherein the match between the search query and the advertisement is determined based on one or more attributes.

13. The computer program product as claimed in claim 9, wherein the match between the search query and the advertisement is determined using a matching algorithms.

14. The computer program product as claimed in claim 9 and further comprising:
generating an auction model by the website, wherein the auction model is used to propose one or more bids by a plurality of advertisers to display a corresponding plurality of advertisements.

15. The computer program product as claimed in claim 9, wherein the advertiser is required to pay a price in response to displaying the theme based advertisement on the search box.

16. The computer program product as claimed in claim 9, wherein the theme based advertisement is clickable by the user.

17. A system for displaying advertisements on a search box, the system comprising:
an electronic device;
a communication interface in electronic communication with the electronic device;
a memory that stores instructions; and
a processor responsive to the instructions to
receive a search query, from a user, in a search box present on a webpage of a website;
determine a match between the search query and an advertisement that is relevant to the search query, wherein the match is determined by comparing the search query with a plurality of advertisements present in an advertisement database;
retrieve the advertisement that is relevant to the search query based on a relevance algorithm, the advertisement being provided by an advertiser winning a bid to display the advertisement;
alter one or more data formats associated with the advertisement to generate a theme based advertisement that corresponds to the search query, the one or more data formats being altered based on a plurality of search box settings to enable embedding of the theme based advertisement on the search box; and
display, to the user, the theme based advertisement on at least one of the search box and areas encircling the search box.

18. The system as claimed in claim 17, wherein the processor is further configured to retrieve at least one of a plurality of search results associated with the search query and a plurality of text advertisements.

19. The system as claimed in claim 17, wherein the processor is further configured to display at least one of a plurality of search results associated with the search query and a plurality of text advertisements.

20. The system as claimed in claim 17, wherein the processor is further configured to generate an auction model by the website, wherein the auction model is used to propose one or more bids by a plurality of advertisers to display a corresponding plurality of advertisements.

21. The system as claimed in claim 17, wherein the theme based advertisement is clickable by the user.
